(19) United States
(12) Patent Application Publication
(10) Pub. No.: US 2021/0171320 A1
(43) Pub. Date: Jun. 10, 2021

(54) Escalator-monitoring/operable device and methods of use thereof

(71) Applicant: John R. Dong, Toronto (CA)

(72) Inventor: John R. Dong, Toronto (CA)

(21) Appl. No.: 16/703,944

(22) Filed: Dec. 5, 2019

(51) Int. Cl. B66B 29/00; B66B 25/00; B66B 27/00; B66B 31/02

(52) U.S. Cl. CPC B66B 29/005; B66B 31/02; B66B 27/00; B66B 25/003

(57) ABSTRACT

An escalator-monitoring device/method deliver quick/easy installation without affecting the escalator's safety/warranty, minimizing operation costs/risks/liabilities/downtimes, and maximizing capitalization by reliable detecting being normal, abnormal/unsafe, usage and users' heights, alerting the unsafe users, notifying maintenance/traffic-control personnel with pinpointed occurrence(s), receiving/replying requests for state in real time, and uploading the detected big data to computing/IoT cloud(s) at a system preset interval.

### FIELD OF THE INVENTION

The prevent invention relates generally to escalator-monitoring. More particularly, the present invention relates to a device and methods for detecting/alerting unsafe operation and users, detecting running state/events, notifying unsafe/abnormal occurrences, providing the state to a requester and sending detected data to computing/IoT cloud(s). Some of its functions, such as detecting usage and users' heights, can also be used other fields demanding head/height counting.

### BACKGROUND

Escalators are commonly operated in subway stations, shopping malls, airports, office buildings, hotels, casinos, sports facilities and many other types of venues. However their accidents occur thousands times each year in US alone, often resulting in serious injuries. The reasons for the accidents vary but many accidents involving injury can be attributed to their property owners, maintenance companies and manufacturers. The most common theories of liability in escalator accidents are product liability and negligence. One of the most effective preventions is that every user hold their escalator handrails when using. Not holding handrail is prone to fall and dangerous, not only for the first faller, but may also trigger a “domino effect” of falls. Escalator-related lawsuits/litigations have occurred. However, it is not uncommon that some of the users do not hold their handrails. For this purpose, devices which can detect the not-hold-handrail users and alert the users to hold the handrail before any loss of balance can occur are needed.

Next, escalators' abnormal/unsafe events, such as “Jerky movements”, “Sudden acceleration”, “Sudden deceleration”, “Reversing direction”, “Missing stair step(s)”, unexpected stops, occur once a while. Another of the most effective preventions is to find/fix any unsafe/abnormal occurrences at the earliest. However, most escalators had been outsourced and have nobody on their sites to monitor, plus some of the event occurrences can hardly be observed/identified instantly, let alone to report/fix them. For this purpose, devices which can detect/identify the events and notify needed personnel, such as maintenance and/or traffic-control, the event occurrences automatically, fast and cost-effectively are needed, but absent.

Next, many organizations, such as public transportation, charities and third parties, provide subsidized low-fee or free door-to-door transportation services for special groups, such as those who use walking sticks. Many of them are able to use public transportation themselves if escalators at transferring stations are running properly. For this purpose, devices which can receive and provide by replying the escalators' state to requests from the groups of users/providers/systems via internet/intranet can greatly reduce the users' waiting time and the providers' operational costs (by Max capitalizing existing systems), are needed, but absent.

Next, uploading by sending big data of operation and usage, such as operation state, abnormal/unsafe occurrences, running direction, lane/side-precise numbers of users and their heights, number of not-hold-handrail users, number of requests for the operation state, to computing/IoT cloud in real time for being archived, managed and consumed therein can ease and open up new ways to improve, such as planning, operating and manufacturing. For this purpose, devices which can detect/collect/upload the big data to computing/IoT cloud(s) for archiving/managing/consuming automatically, in real time are needed, but absent.

Additionally, dual-lane escalators, typically, have their standing users on one side and walking users on the other side. Even users on single-lane escalators may not be in the mid of their two sides all the time. These cause uneven wear-out and need being repaired at very high costs in a long run. Analogously to vehicular tire rotation, the uneven wear-out can be simply avoided by reversing direction after a certain time period. This can be done at most sites, since their escalators are in pairs and running in opposite directions at the same time. In order to achieving this, numbers of users and/or their body heights/groups in each escalator lane/side need being tracked to assist determining their usage-dependent direction-reversing times.

Previous inventions have described passenger counting, however, these are designed specifically for purposes of U.S. Pat. No. 9,569,902B2 “Passenger counter” for a vehicle/elevator and U.S. Pat. No. 20080212099A1 “Method for counting people passing through a gate”, may be useful for this purpose. But it's not clear if they can count/provide numbers of standing/walking users precise to each running/stopped escalator lane/side. They surely differ from the present invention, such as below:
1. Use/install dedicated sensors to count passengers;
2. Their sensor installation accesses/interfaces the vehicle/escalator, so do raise safety/warranty concern and requires hard-to-get permission;
3. Do not provide passenger body height information;
4. Their passenger counts are stored locally, unclear if associated costs/easiness to collect, manage and consume, instead of automatic uploading/sending to computing IoT cloud(s) in real time; plus
5. Do not detect/notify/alert unsafe users and unsafe operations.

Heretofore, an escalator-monitoring/operable device and methods for
detecting and alerting not-hold-handrail users in real time;
detecting running state: normal, unsafe/abnormal, and usage, users' heights in real time;
identifying (pinpointing) the unsafe/abnormal occurrences, such as “Jerky movements”, “Sudden acceleration”, “Sudden deceleration”, “Reversing direction”, “Missing stair step” and unexpected “Stopped”, and notifying their maintenance personnel and/or traffic control in real time;
receiving/replying requests for the running state with the latest via internet/intranet in real time;
uploading/sending the detected data to computing/IoT cloud(s) at a system preset interval for being archived, managed and consumed; and
not requiring hard-to-get installation permission due to no safety/warranty affected;
   alleviate safety for both the escalator’ users and its operation, reduce costs/risks (e.g. repairing, insurance premiums, potential litigation), down-time and owners' (known) liability in automatic, real-time, cost-effective manner.

### BRIEF DESCRIPTION OF THE DRAWINGS

NOTE: For simplicity of illustration, WI-FI®, Ethernet®, Internet, electric power supply, PCB (Printed Circuit Board), AD convertor, memory ICs, resistors, capacitors, housing/enclosure, support/stand, nuts, bolts and industry hardware are not depicted as they are known to those with skill in the art. When they are shown, it is purely for illustrative purposes and not intended to capture all embodiments of the invention disclosed.

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is a side view of an escalator and merely illustrative;

FIG. 2 is side view of an escalator and illustrating its decomposed vertical/horizontal moving components;

FIG. 3 is a side view of an escalator and the escalator-sensor's optimal locations according to a first embodiment;

FIG. 4 is waveform of the escalator-sensor's converted height values (as positioned in FIG. 3) while the sensed escalator is running and no user passing;

FIG. 5 is waveform in another running direction of that in FIG. 4;

FIG. 6 is waveform of the escalator-sensor's converted height values while users of different body heights are standing on single step and relationship to FIG. 4;

FIG. 7 is waveform of the escalator-sensor's converted height values while a user is standing on two consecutive steps;

FIG. 8 is waveform of the sensor's converted height values while a user is walking in the escalator's moving direction;

FIG. 9 is a close-up and perspective view of a single-lane escalator and positions of the escalator-sensor and the arm-sensor(s) according to a first embodiment;

FIG. 10 is a close-up and perspective view of a dual-lane escalator and positions of the escalator-sensor(s) and the arm-sensor(s) according to a first embodiment;

FIG. 11 is relational waveform of converted height values of the escalator-sensor and the arm-sensor while different height users are standing on single step and holding the handrail by their hands/wrists/arms;

FIG. 12 is a side view of an escalator and an alternative way to position the escalator-sensor according to a second embodiment;

FIG. 13 is waveform of (FIG. 12) the alternatively installed escalator-sensor output or its converted digital values;

FIG. 14 is a flowchart showing the method/algorithm performing detection/determining an escalator's normal state “running”, “stopped”, abnormal occurrences according to a first embodiment;

FIG. 15 is a flowchart showing the method/algorithm performing detection, determining/flagging users' presenting (body passing) and counting numbers of users/heights according to the a first embodiment;

FIG. 16 is a flowchart illustrating the method/algorithm performing detection, determining and flagging arm presenting (arm passing) according to a first embodiment; and

FIG. 17 is a flowchart illustrating the method/algorithm performing detection, determining, outputting/signaling to activate external alert circuits according to a first embodiment.

### DETAILED DESCRIPTION

Embodiments of the present invention comprise an operable device and methods for monitoring escalators. Embodiments of the device basically comprise:

one or more sensing device(s)/sensor(s) installed above an escalator, said sensors, which collectively detect the escalator's operation (escalator-sensor) and its users' hands/wrists/arms (arm-sensor), both sensors detect height change in distance between the escalator's stair step/user and the sensor(s) at a time;

one or more processing device(s) which comprise processor(s) or a computer integrated with the processor, a memory, an IO and IoT device, coupled to each one of said sensors to receive data therefrom;

a non-transitory computer readable storage medium which comprises a memory and is used for storing program and data for access by the program being executed on the processor/computer;

an IO device or the IO integrated in the processor/computer, coupled to said processor/computer, to input, output therein data, one or more signals;

an IoT device or the IoT integrated in the processor/computer, coupled to said processor/computer to send out one or emails, transmit therein data/message computing clouds and/or at least one MQTT publisher over private and/or public internet/intranet; and

one or more programs, wherein the one or more programs are stored in the memory and configured to be executed by the processor/computer, the one or more programs including instructions and/or functional blocks (nodes) and/or (FPGA/CPLD) descriptors for:

acquiring data from said escalator-sensors and arm-sensors, wherein to receive data therefrom;

acquiring the data;

analyzing the data to determine escalator/user data, flags of escalator/user data, cycle range, cycle times, cycle times' inequality/ratio, sums of absolute delta consecutive escalator step heights, groups of consecutive user data, utilizing the processing device;

identifying a predetermined state/(abnormal/unsafe) event and usage of the escalator, and the user's height in order to alert/notify/reply/upload, based on the analyzing, utilizing the processing device, the state/event, such as: detecting not-hold-handrail users, operation state: normal (“running”), abnormal occurrences (“Jerky movements”, “Sudden acceleration”, “Sudden deceleration”, “Missing stair step”, “Reversing direction”, “Stopped”), receiving/replying a request for the state and uploading the detected data to computing/IoT cloud(s) at a system preset interval;

alerting the not-hold-handrail user, based on the identifying, utilizing the processing device and the IO device, including: outputting one or more signals to trigger/activate external device/circuit to alert the not-hold-handrail user;

notifying the event occurrence(s), based on the identifying, utilizing the processor(s) and the IoT device, including: sending email(s) to notify the escalator's maintenance and/or traffic-control personnel when any abnormal event has occurred;

receiving/replying a request for the state, based on the identifying, utilizing the processor(s) and the IoT device, including: receiving the request and replying by sending the identified state to the request via internet/intranet; and uploading, based on the identifying, utilizing the processor and the IoT device, including: sending the identified data to one or more computing/IoT cloud(s) via internet/intranet at a system preset interval, such as every 3 minutes.

It should be appreciated that the device described above is only one example of an escalator-monitoring/operable device, and that the device may have more or fewer components, may combine two or more components, or may have a different configuration or arrangement of the components. The various components may be implemented in hardware, software or a combination of hardware and software, including one or more signal processing and/or application specific integrated circuits. For example, depending on types of sensors used, analog or digital, AD converter(s) need being used to connect/convert analog sensors' output before transmitting to the processor/computer, but no need for digital sensors.

The types of the processor/computer can be traditional instruction, such as a single board IoT computer Raspberry Pi™, as well as FPGA (Field Programmable Gate Array)/CPLD (Complex Programmable Logic Device). FPGA/CPLD can be programmed into application-specific state machines, counters, logic operators, IOs and interfaces by descriptors (e.g. a Flip/Flop cell) in HDL (Hardware Description Language), such as VHDL™, Verilog™. Multiple processors, including FPGA/CPLD, can optionally used to divide tasks/functions for the invention. NODE-RED™, software supported by the Raspberry Pi™, offers drag & drop functional blocks (nodes). Some of the blocks (nodes) only need being configured to function, such as IoT block for sending data to clouds, email block for sending emails, while some can be programmed by instructions, such as JavaScript™ block to program in Javascript™, GPIO block to input/output 10 signals.

The form of the one or more programs can be any combinations of instructions (e.g. Raspberry Pi™/JavaScript™), functional blocks (e.g. Raspberry Pi™/NODE-RED™) and descriptors (e.g. FPGA/CPLD, HDL).

The advantages of using embodiments of the device/methods are many, such as below listed:
increase user/operation safety and reduce owners' liability;
reduce various costs and down time;
reduce waiting time/money for special groups' users/providers;
not require hard-to-get permission due to its not-affect-safety/warranty installation; and
no privacy concerns like video cameras are used.

### Terminology

The terms and phrases as indicated in quotes (“ ”) in this section are intended to have the meaning ascribed to them in this Terminology section applied to them throughout this document including the claims unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive rather the term is inclusive meaning: either or both.

References in the specification to “one embodiment”, “an embodiment”, “an alternative embodiment” and similar phrases mean that a particular feature, structure, or characteristic described in connection with the embodiment is included in at least an embodiment of the invention. The appearances of the phrase “in one embodiment” in various places in the specification are not necessarily all meant to refer to the same embodiment.

The term “couple” or “coupled” as used in this specification and the appended claims refers to either an indirect or direct connection between the identified elements, components or objects. Often the manner of the coupling will be related specifically to the manner in which the two coupled elements interact. Directional and/or relationary terms such as, but not limited to, left, right, top, bottom, vertical, horizontal, upward, downward, back, front and lateral are relative to each other and are dependent on the specific orientation of an applicable element or article, and are used accordingly to aid in the description of the various embodiments and are not necessarily intended to be construed as limiting.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

As applicable, the terms “about” and “generally” as used herein unless otherwise indicated mean a margin of ±20%. Also, as applicable, the term “substantially” as used herein unless otherwise indicated means a margin of ±10%. Concerning angular measurements, “about” or “generally” refer to ±10 degrees and “substantially” refers to ±5.0 degrees unless otherwise indicated. It is to be appreciated that not all uses of the above terms are quantifiable such that the referenced ranges can be applied.

### A First Embodiment of an Escalator-Monitoring/Operable Device and Variations Thereof

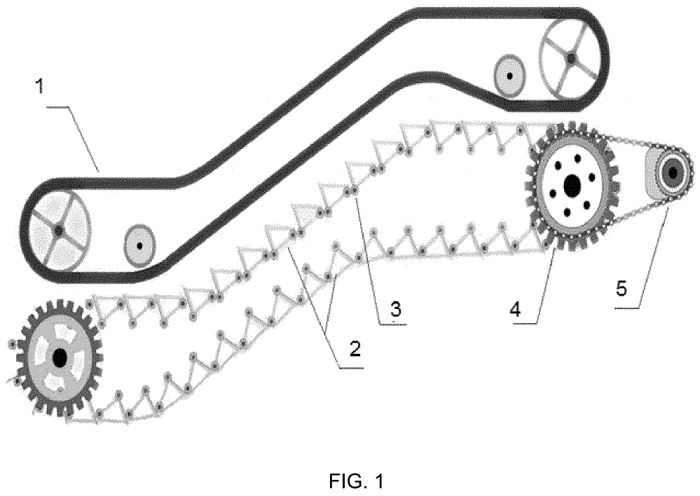

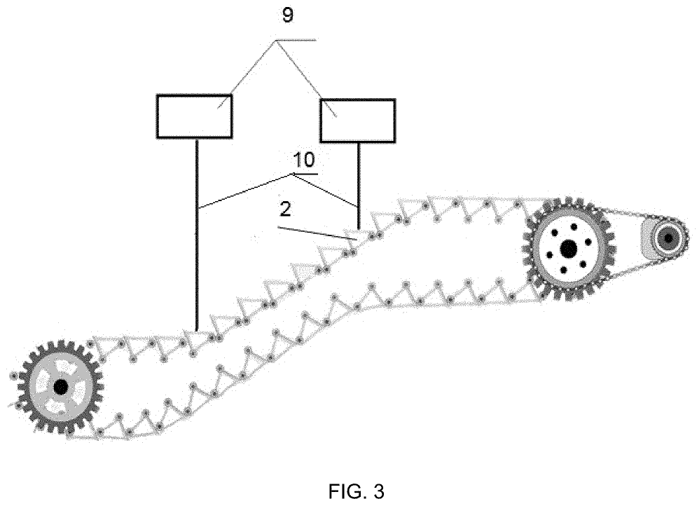

Exemplary embodiments of the device including many variations and uses thereof are illustrated in FIGS. 1-17. Specifically, one version of a first embodiment of the device is best illustrated in FIGS. 3-10, FIGS. 14-17.

Attention is now directed towards basic structure and components of an escalator are illustrated in FIG. 1, handrail 1, steps 2, step-wheels 3, a driving gear 4 and an electrical motor 5.

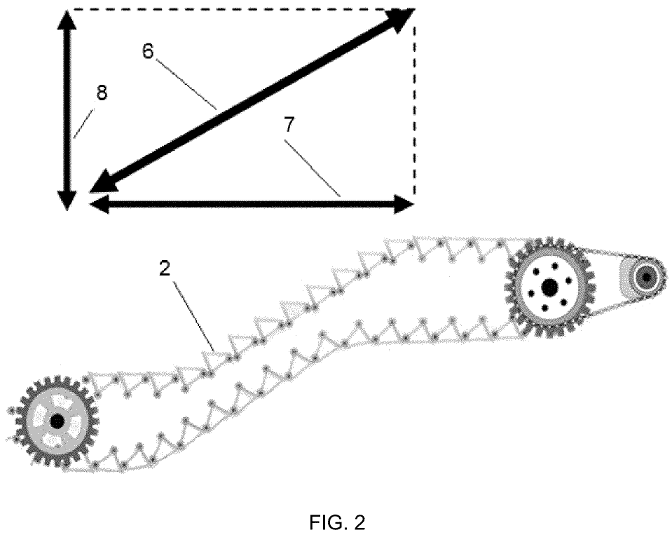

Attention is now directed towards an escalator's “Moving Components” as illustrated in FIG. 2. The escalator's moving 6 can be decomposed into horizontal moving component 7 and vertical moving component 8. However, the vertical moving component 8 can hardly be observed/identified by naked eyes, mainly because it's small, dynamic, fast and no (good) reference around. Its existence can be confirmed by measuring vertical distance variation using high resolution/speed distance-sensing devices/sensor(s) as illustrated in FIG. 3. FIG. 3 illustrates an exemplary way, using the distance sensors 9, with their sensing paths 10, sense down escalator steps above, at specific/optimal locations. The sensing paths 10 can be optical paths for optical sensors or sonic paths for supersonic sensors.

One of 3 dimensions of the optimal locations, generally between 3^{rd} to 5^{th} steps from its upper and lower entrances/exits, can be found by following method steps:
A. Visually pick the locations where have the biggest vertical moving range, typically between 3^{rd} to 5^{th} steps from its upper and lower entrances/exits.
B. Using a distance sensing device/sensor and/or data logger or storage oscilloscope scan along the escalator steps at the same height above, especially the visual picked areas, to measure/find/mark the points with the biggest vertical variation range than those of their neighbors.
C. Repeat the above 2 steps to fine-tune, verify and record the dimensions of the optimal locations and their associated periodic attributes, cycle times (T1, T2) and variation range (V1, V2) thereafter.
   T1 refer to the cycle time from Minimum step height V1 to Maximum step V2;
   T2 refer to the cycle time from Maximum step height V2 to Minimum step height V1;
   T1, T2 can also be measured by their equivalent numbers of the data/acquision at sampling and/or clock rate used.
D. Repeat the above steps on final installed devices and/or re-calibrate if necessary to ensure correct operation.

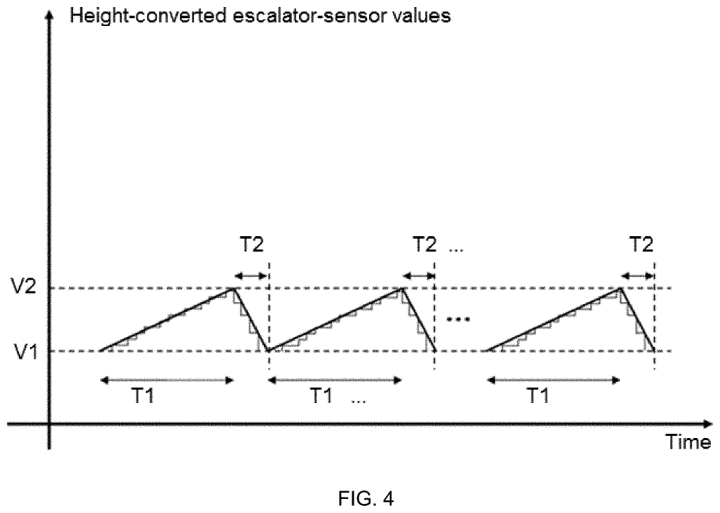

FIG. 4 illustrates one of running directions' waveform of the escalator-sensors' output or their “Height-converted values” and associated periodicity, cycle times (T1, T2). The small “stairs” in the waveform are due to high sampling rate so the “redundant” numbers are acquired.

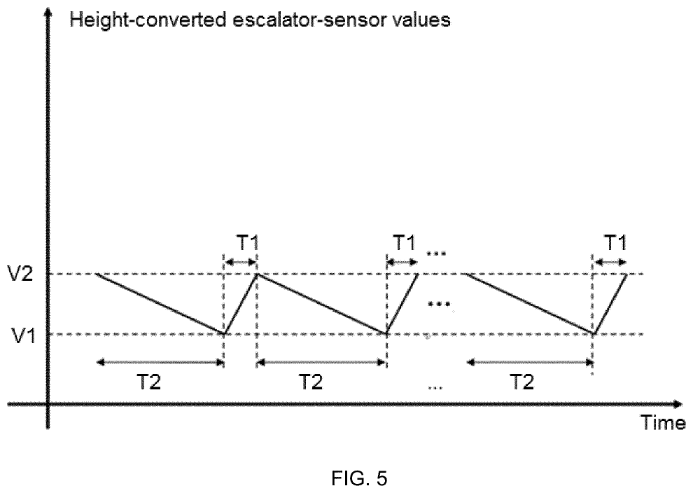

FIG. 5 illustrates another running direction's waveform of the escalator-sensors' output or their “Height-converted values” which is in horizontal-axis-mirrored phase to that in FIG. 4. The phase difference is due to different running-direction, but they have the same nature, such as periodicity. The phase will follow/change instantly, if the direction changes. This can be used to detect direction and/or its change. The phase info can be measured and/or detected by ratio and/or logic relationship of T1 and T2, for example, T1/T2>1, T1>T2 for one of running directions, T1/T2<1, T1<T2 for another direction.

A directly sensed height of using this configuration is the distance from the sensor to top of an object underneath, i.e. not its actual height. For example, if a sensor is at 2.5 meter above the escalator, a 1.73-meter user will be measured as 2.5-1.73=0.77 meters instead of 1.73 meters, if measuring error is ignored. Actual Height can be converted by following:

Actual Height=Sensor's height−Sensed distance

For simplifying/intuitive description purpose, use “Height-converted” as Actual Height thereafter, although sensed one can do the same.

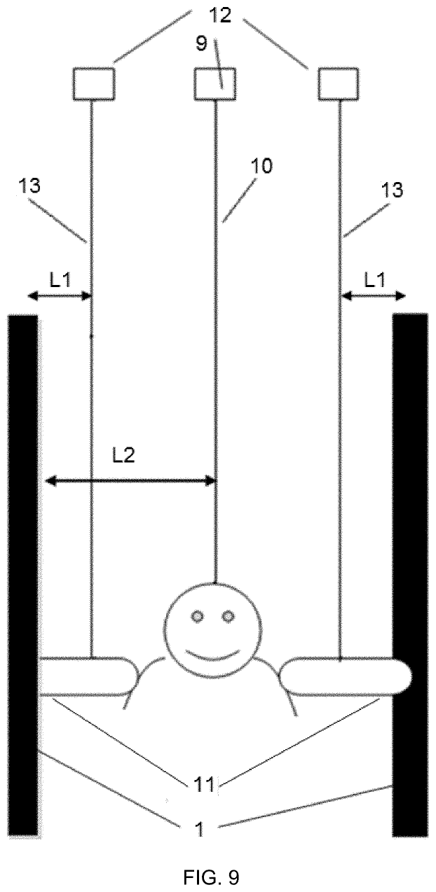

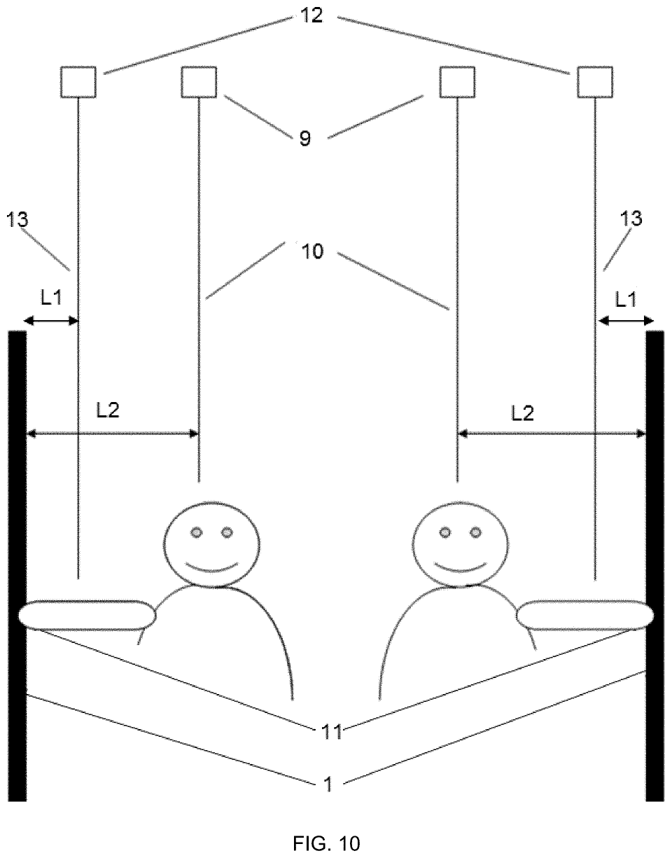

The other dimensions of escalator-sensors 9 with sensing paths 13 and arm-sensors 12 with sensing paths 13 are illustrated for single-lane escalator in FIG. 9, dual-lane escalator in FIG. 10. The height of the escalator-sensors is about 2.5 meters at the optimal locations, their horizontal distance to their nearest handrail L2, typically, between 25 cm and 50 cm, at or around one of the optimal locations. An arm-sensor is installed in location to sense the users' hands/wrists/arms when holding their handrails. This, most likely, can detect their holding, but no guaranty. However, if no valid arm passing/signal before, during and after a body passing, can safely determine that this user is not holding its handrail.

Arm-sensors are typically near the escalator-sensors, horizontal distance L1 from their nearest handrails, typically between a few to tens of cm as illustrated in FIG. 9 and FIG. 10.

Both of the escalator-sensors and the arm-sensors are installed by an individual or an entity at the locations determined by the 3 dimensions described. They can be installed on single and/or both sides of the escalator, regardless single or double lanes.

The escalator-sensors and arm-sensors for the invention, generally, have resolution less than 3 cm, frequency response more than 24 Hz and sensing distance more than 2.5 meters.

Some of the suitable sensors for the invention are
ModelHC-SR04 from SparkFun™ Electronics and Adafrsuit™ Industries LLC;
ModeIGP2Y0A710K0F from Sharp™ Electronics.

In this installation configuration as illustrated in FIG. 3, FIG. 9 and FIG. 10, escalator-sensors sense the escalator's step and the user height at a time. So the data received from the escalator-sensors can be either escalator data or body data. The data is escalator data when no user underneath when a user underneath, or user data when the user is passing undernearth. Type of the data, escalator data or body data, can be easily classified/separated by comparing the data to thresholds of the escalator and the users, such as V1/V2 in FIGS. 4 to 8, 11. Keep/flag/store flags of both data types and both types' data for further analysis/identification, such as by variables in program languages/instructions. The advantage of this is able to get their users' body heights/groups info without using/installing dedicated body-sensors, even user body depth info if needed. The sensed body heights can be reduced into a fewer height groups, such as 4 groups: [0.7-1 m, 1-1.6, 1.6-1.8, 1.8-2.2], when individual heights are unnecessary.

The disadvantage of this: there may be a small “dead window” without escalator data when users are passing through all the sensors (for escalator and arm) at the same time, It can detect the escalator when a gap and/or lack of the user under any of the sensors. This is not a problem for this type of application since its probability/duration is small and short, besides the 2^{nd} exemplary can overcome it.

Finding how users act/behave on escalators, such as stand, stand on single step, stand on 2-consecutive steps, walk, is also useful, since sensed data and their waveforms contain/show these differences.

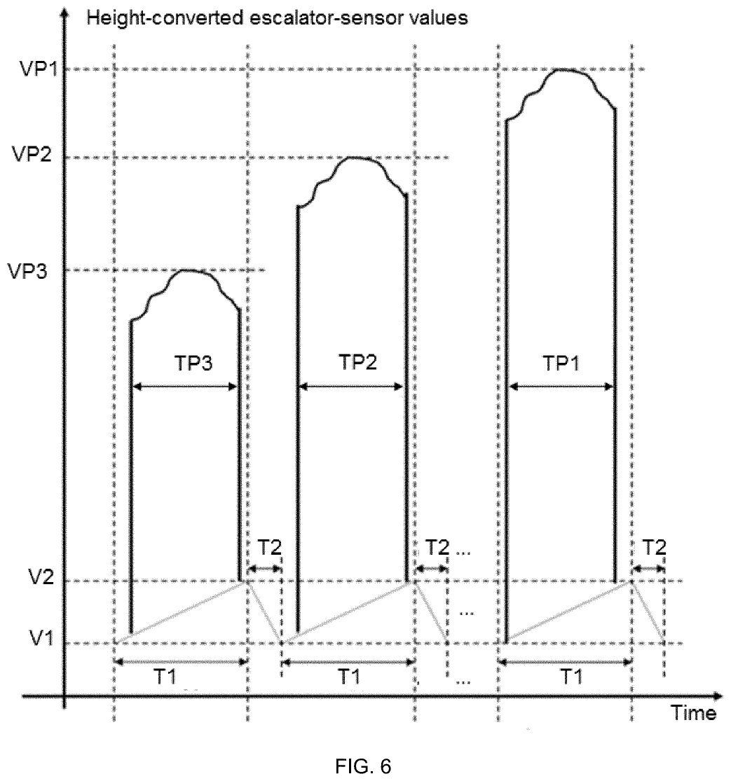

FIG. 6 illustrates the waveform of uses' body heights, VP1, VP2, VP3, associated body passing times/depths, TP1, TP2 and TP3 respectively while standing on single step, relationship to a passing step's vertical range/times, V1, V2, T1, T2. This also agrees with common sense/assumption: body height is much more than Maximum step height V2 (VP1-3>>V2), the body passing times (TP1-3) are around one cycle time T1+T2.

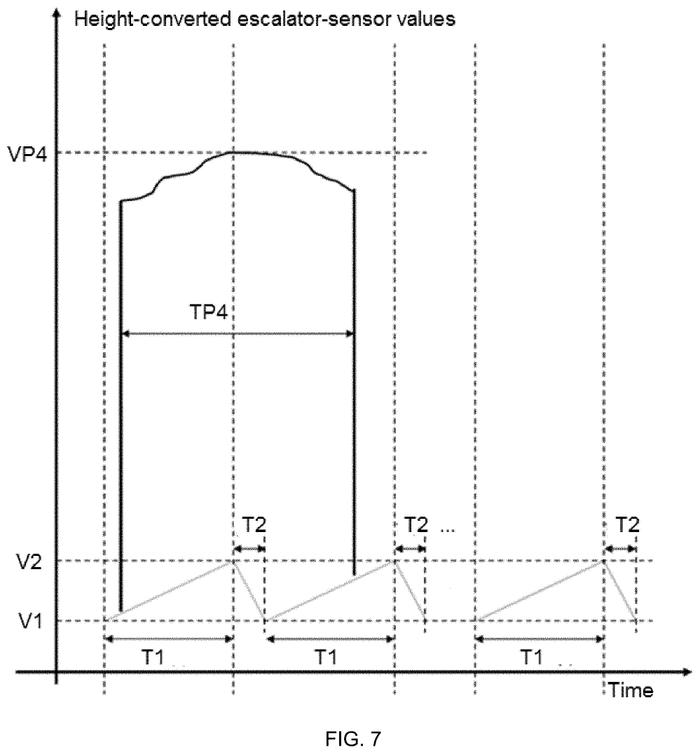

FIG. 7 illustrates the waveforms of a user's body heights VP4, associated body passing time/depth TP4 while standing on 2-secutive steps, relationship to a passing step's vertical range/time, V1, V2, T1, T2. This also confirms common sense/assumption: 2-step-standing body passing time (TP4) is around twice of cycle time 2*(T1+T2).

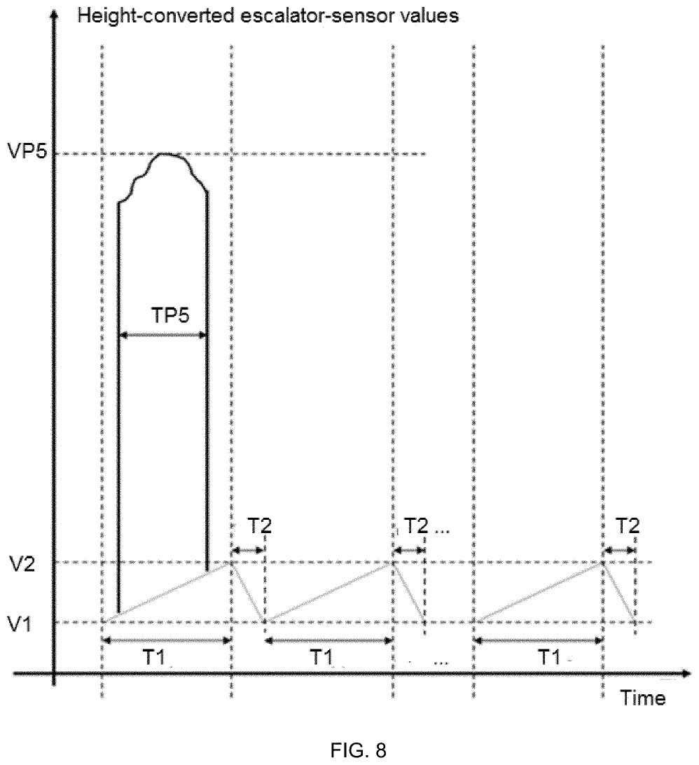

FIG. 8 illustrates the waveforms of a user's body height VP5, associated body passing time/depth TP5 while walking in running direction, relationship to a passing step's vertical range/time, V1, V2, T1, T2. This also confirms common sense/assumption: walking user body passing time (TP5) is less/around cycle time (T1+T2).

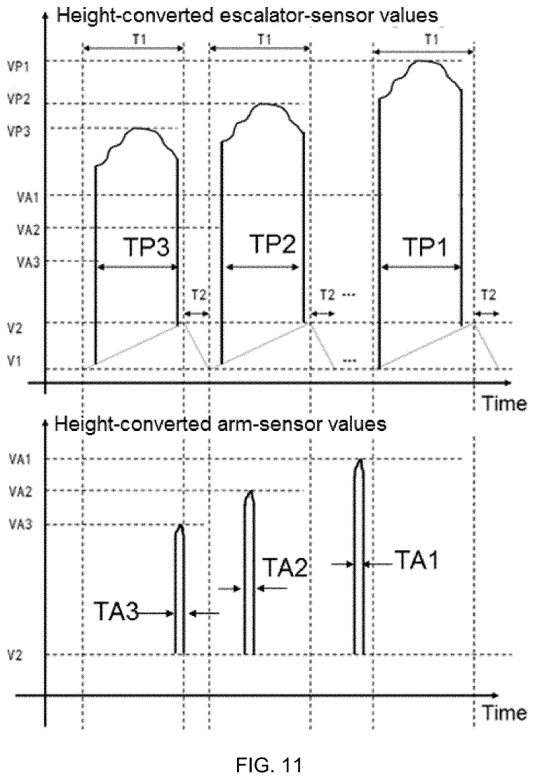

FIG. 11 illustrates waveforms of body passing an escalator-sensor and arm passing an arm-sensor while standing on single step and holding the handrail, their body heights, VP1, VP2, VP3, their body passing times, TP1, TP2, TP3, their associated arm heights, VA1, VA2, VA3, and associated arm-passing times, TA1, TA2, TA3 which are before, during and after their associated body passing. This also agrees/confirms common sense/assumption, such as arms (passing time TA1-3) narrower than body (passing time, TP1-3), no periodicity for body passing and arm passing.

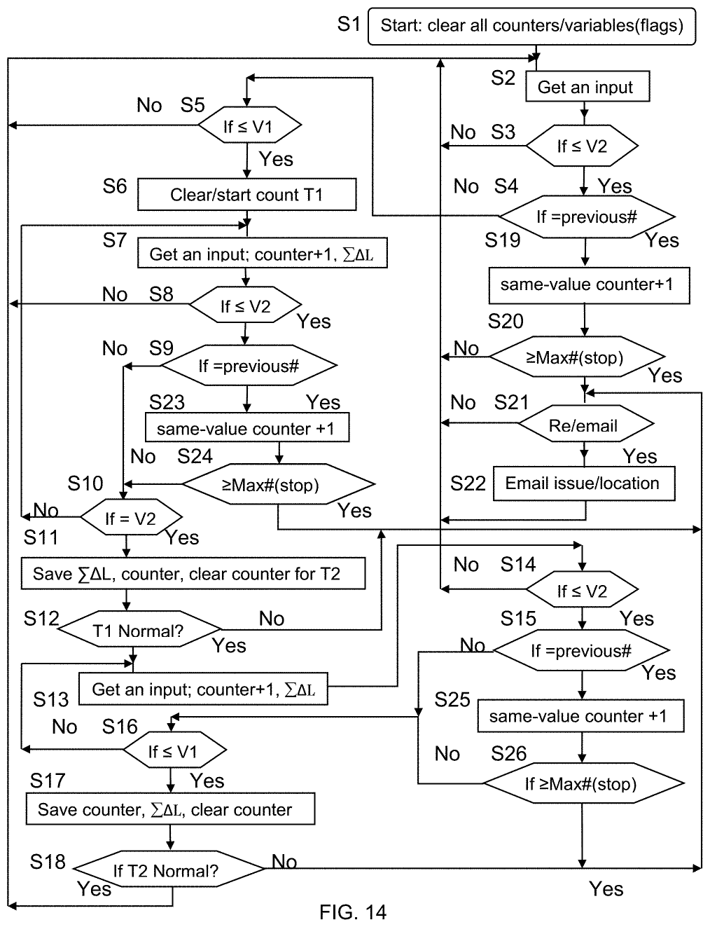

Adapting IoT computer Raspberry Pi™ to implement/execute the flowcharts/algorithms illustrated in FIGS. 14-17 can benefit to:
eliminate separate on-board 10, memory, IoT-device instead of its integrated ones. For example, it has a SD card interface/slot where can directly insert/plug a Flash Memory into the slot for its reading/writing/deleting access. A Flash Memory in the slot can serve as non-transitory computer readable storage medium for storing data and program(s) executed by the Raspberry Pi™. Raspberry Pi™ even includes a Flash Memory and have OS (Operating System) installed;
reduce costs/time, e.g. using its supported software NODE-RED's blocks.

Alternatively adding a FPGA/CPLD to take over some of Raspberry Pi™ tasks for this implementation, such as detection, counting and IO data/signal, by implemented FPGA/CPLD state machines, counters, inputting data from sensors, outputting 10 signals to externally, can also be done. But communication between them (the Raspberry Pi™ and the FPGA/CPLD) is needed. The communication can be implemented in many ways, such as via I²C and/or SPI interfaces in both of them. I²C and SPI are already provided and ready to use in a Raspberry Pi™ and commonly used in FPGA/CPLD as well.

The methods/algorithms can be executed in parallel and simultaneously, such as flowcharts/algorithms illustrated in FIGS. 14-17.

The attributes/thresholds used are defined/re-outlined thereafter:

V1, a constant number, refers to the lowest height of an escalator floor step at the sensing position illustrated in FIGS. 3-11;

V2, a constant number, refers to the highest height of an escalator floor step at sensing position illustrated in FIGS. 3-11;

T1, a constant number, refers to the periodic cycle time from V1 to V2 as illustrated in FIGS. 4-8, 11;

T2, a constant number, refers to the periodic cycle time from V2 to V1 as illustrated in FIGS. 4-8, 11;

VPH, a constant number, refer to Minimum body height as a threshold. A realistic value, such as toddler's 70 cm and/or its equivalent digital one is a good to use. It is much greater than Maximum step height V2, for example about 8 cm. Thresholds, such as VPH, are used to detect/determine/validate data class belonging to (e.g. escalator or body) and signal/Flag of body passing. For example, detect/flag by comparing the data received from the sensors to the VPH, if greater or equal to the Minimum body height (WPH), then body data and/or body passing, otherwise if less or equal to the Maximum step height (≤V2 and ≥V1), then escalator data, if less than V1, means missing stair step(s) occurred.

VAH, a constant number, refers to Minimum arm height as a threshold, generally, about handrail height. VAH is higher than Maximum step height V2 and used to detect/determine/validate data and signal/Flag of arm passing. For example, detect by comparing the data received from the arm-sensors to the VAH, if greater or equal to the Minimum arm height (≥VAH), then valid arm data and/or arm passing.

Max number, a constant number (used in FIG. 14), refers the Maximum/total number of input data and/or count which is equivalent to time within one cycle (T1+T2) at sampling rate used, or optionally, plus additional leeway offset; Same-value counter is a variable/counter (used in FIG. 14) to count number of time(s) of same value escalator data (within V1 and V2) received.

List of the Invention's Methods/Algorithms/Rules

| Detection | Category | Rules to detect/determine |
|---|---|---|
| “running” | Normal operation state | If detected consecutive escalator data agree with |
| | | preset periodic cycle times (T1, T2) and range (V1, V2) |
| “Stopped” | Abnormal occurrence | If data received are the same value of escalator |
| | | data and more than Max number over allowed tolerance |
| “Jerky movements” | Unsafe/abnormal occurrence | If either detected ΣΔL in T1/T2 differs vertical |
| | | range difference (V2 − V1) over allowed tolerance |
| “Missing stair step” | Unsafe/abnormal occurrence | If escalator data less than Minimum threshold V1 |
| “Sudden acceleration | Unsafe/abnormal occurrence | If number of counts/inputs differs (over or under) |
| or deceleration” | | number of counts/inputs in T1/T2 at sampling |
| | | rate/clock used over allowed tolerance |
| Running direction | Operation state | Defining/link one of known directions to ratio |
| | | and/or logic relationship of T1, T2 detected |
| “Reversing direction” | Unsafe/abnormal occurrence | If ratio and/or logic relationship of T1, T2 changed |
| | | from previously detected/known |
| Not-hold-handrail users | Unsafe usage | If no arm passing, one cycle time (T1 + T2) before/after |
| | | a body passing, i.e. no arm passing from one cycle time |
| | | before to/until one cycle time after a body passing. |

List of in-Response-to Actions of the Invention's Methods/Rules

| In-response-to | Action |
|---|---|
| Abnormal occurrence | Sending notifying email(s), such as “Stopped” |
| Not-hold-handrail | Outputting one or more signal(s) to activate external |
| | circuit(s) to alert/remind |
| Receiving/Replying | Receiving/replying by sending the latest operation state |
| Requests for the state | to requests for the state via, e.g. a configured NODE-RED |
| | HTTP block (node). Alternatively sending the state to MQTT |
| | publisher(s) and letting the publisher(s) to reply requests |
| | from MQTT subscribers |
| Time to send data to cloud | Uploading by sending the detected data to computing/IoT |
| | cloud(s) when a time tick of a system preset interval is due |

The analyzing of the Method/operations further comprising:

| Detection | Rules to detect/determine |
|---|---|
| generic | Comparing to their preset thresholds or stored values |
| body data | if equal or greater than preset Minimum body height VPH |
| escalator data | if equal or less than the Maximum step height V2 |
| arm-data | if equal or greater than preset Minimum arm height VAH |
| body passing | if all the consecutive input data are body data |
| arm passing | if all the consecutive input data are arm data |
| sum of absolute delta | accumulating of absolute difference of each 2-consecutive |
| consecutive escalator | escalator data received during cycle intervals: |
| step heights ΣΔL | T1(from Minimum to Maximum) and T2(from Maximum to Minimum) |
| periodicity | If all consecutively received data are escalator data and |
| | vary within fixed/same value ranges and at fixed/same |
| | time cycles; the value ranges are Minimum step height V1 and |
| | Maximum step height V2; and the cycle times are T1 and T2 |
| | and/or equivalent number of input/count in T1 and T2 |

Attention now directed towards flowchart/algorithm for detecting escalator operation state is illustrated in FIG. 14 with scenarios below:

Scenario 1 running (without user passing)

Scenario 2 stopped

Scenario 3 user passing

Now walking through scenario 1 running detection, in steps S1-S18

S1: after power-up start to clear all counters/variables (flags) used, go S2;

S2: get an input data from an escalator-sensor, go S3;

S3: compare if the input data is (Yes) escalator data, go S4;

S4: compare if the data (No) equal to last escalator data, go S5;

S5: compare if the data is Minimum step height V1: (Yes) go S6, otherwise go S2 to get next input data; using V1 instead of =V1 for noise/fluctuation concern;

S6: clear/start counter to count expected T1 cycle and go S7;

S7: get an input data, increase number of input counter, calculate ΣΔL=sum of absolute data difference of between this input and last one and go S8;

S8: compare if the input is escalator data: (Yes) go S9, otherwise go S2;

S9: compare if the new data equal to previous one, (No) go S10, otherwise S23;

S10: compare if the new data equal to Maximum step V2, (Yes) expected T1 cycle ended and go S11, otherwise go back S7 to continue expected T1;

S11: save ΣΔL, number of input data for T1, go S12

S12: compare if the actual calculated match expected in T1:

If ΣΔL differs vertical range (V2-V1) over allowed tolerance, mean abnormal “Jerky Movements” happed during T1 cycle and go S21/S22 to check if needs re/notifying the abnormal occurrence via email, otherwise go S2;

If number of input data saved differs number of input data in T1 at sampling rate/clock used over allowed tolerance, mean abnormal “Sudden Acceleration or Deceleration” happened in T1 cycle, go S21/S22 to check if needs re/notifying the abnormal occurrence via email, otherwise go S2.

If ΣΔL and number of input data match, mean normal/running so far, go S13 for expected T2

S13: get an input data, increase number of input counter, calculate ΣΔL and go S14;

S14: compare if the input is escalator data: (Yes) go S15, otherwise go S2;

S15: compare if the new data equal to previous one, (No) go S16, otherwise S25;

S16: compare if the data is Minimum step height V1: (Yes) expected T2 ended and go S17, otherwise go S13 to continue the expected T2;

S17: save ΣΔL, number of input data for T2, clear counter, go S18

S18: compare if the actual calculated match expected in T2:

If ΣΔL differs vertical range (V2-V1) over allowed tolerance, mean abnormal “Jerky Movements” happened during T2 cycle and go S21/S22 to check if needs re/notifying the abnormal occurrence via email, otherwise go S2;

If number of input data saved differs number of input data in T2 at sampling rate/clock used over allowed tolerance, mean abnormal “Sudden Acceleration or Deceleration” happened in T2 cycle, go S21/S22 to check if needs re/notifying the abnormal occurrence via email, otherwise go S2;

If either ratio T1(number of input data)/T2(number of input data) and/or their length relationship differs the ones in previous cycle over allowed tolerance, mean abnormal “Sudden Reversing Direction” occurred, go S21/S22 to check if needs re/notifying the abnormal occurrence via email, otherwise go S2;

If all (ΣΔL, number of input data, T1/T2) match, mean normal/running, go S2. Now walking through scenario 2 stopped detection under 3 conditions (redundant steps omitted):

Condition 1 “Stopped” detected before start T1 cycle in steps [S1-4, S19-22]

S4: compare if the data (Yes) equal to last escalator data, go S19;

S19: increase same-value counter by 1 and go S20;

S20: compare if the same-value counter more than Max number (number of counts/input data in one cycle T1+T2 at sampling rate/clock) over allowed tolerance, mean abnormal “Stopped” occurred, go S21/S22 to check if needs re/notifying the abnormal occurrence via email, otherwise go S2;

Condition 2 “Stopped” detected during T1 cycle in steps [S1-9, S23-24, S21-22]

S9: compare if the new data equal to previous one, (Yes) go S23, otherwise S10;

S23: increase same-value counter by 1 and go S24;

S24: compare if the same-value counter more than Max number (number of counts/input data in one cycle T1+T2 at sampling rate/clock) over allowed tolerance, (Yes) mean abnormal “Stopped” occurred, go S21/S22 to check if needs re/notifying the abnormal occurrence via email, otherwise go S2.

Condition 3 “Stopped” detected during T2 cycle in steps [S1-15, S25-26, S21-22]

S15: compare if the new data equal to previous one, (Yes) go S25;

S25: increase same-value counter by 1 and go S26;

S26: compare if the same-value counter more than Max number (number of counts/input data in one cycle T1+T2 at sampling rate/clock) over allowed tolerance, (Yes) mean abnormal “Stopped” occurred, go S21/S22 to check if needs re/notifying the abnormal occurrence via email, otherwise go S2.

Now walking through scenario 3 detected body data/passing under 3 conditions:

Condition 1 body data detected before start T1 cycle in steps S1-3

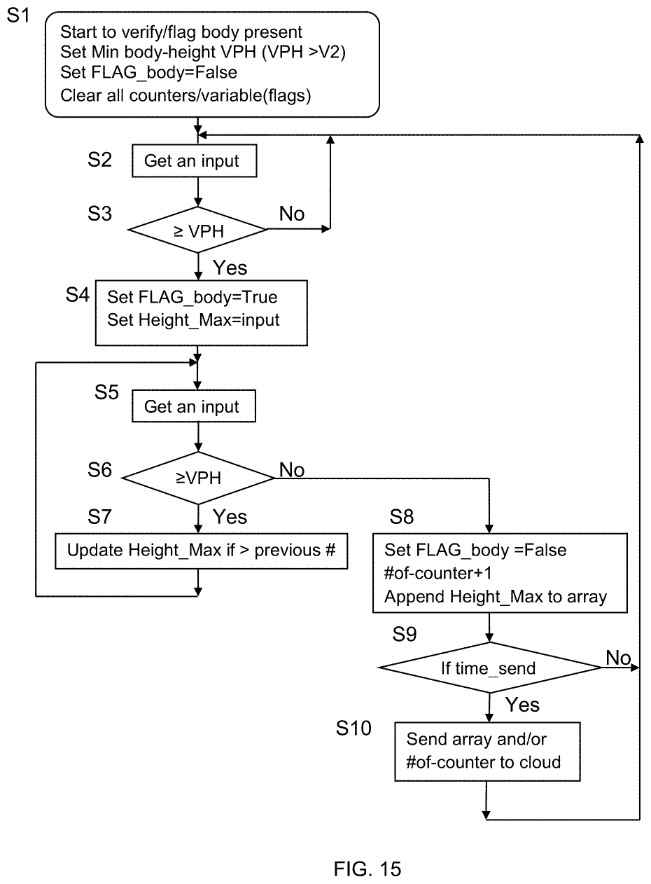

S3: compare if the input data is (No) escalator data, leaves the current body data for simultaneous flowchart/algorithm in FIG. 15 to determine/flag and go S2 to wait for next valid one;

Condition 2 body data detected during T1 cycle in steps in steps S1-8

S8: compare if the input data is (No) escalator data, leaves the current body data for simultaneous flowchart/algorithm in FIG. 15 to determine/flag and go S2 to wait for next valid one;

Condition 3 body data detected during T2 cycle in steps in steps S1-14

S14: compare if the input data is (No) escalator data, leaves the current body data for simultaneous flowchart/algorithm in FIG. 15 to determine/flag and go S2 to wait for next valid one;

Attention: NODE-RED email block (node) used in step S22 needs being configured before executing, such as set email's recipients, subject containing the detailed abnormal message and reporting escalator's address.

FIG. 15 illustrates a flowchart/algorithm for determining/flagging body passing and sending data to cloud.

Determining/flagging a body passing in steps S1-7:

S1: after power-up start to clear all counters/variables (flags), set VPH, go S2;

S2: get an input data from an escalator-sensor, go S3;

S3: compare if the input data is (Yes) body data, go S4, otherwise go S2;

S4: Set body passing Flag=True, Body Height=input data, go S5;

S5: get an input data from escalator-sensor, go S6

S6: compare if the input data is body data, (Yes) go S7, otherwise the body passed and go S8;

S7: update Body Height with the input if bigger, go S5;

Determining/sending detected data to cloud in S8-10:

S8: Set body passing Flag=False, Increase number of user counter by 1, append the Body Height in buffer, go S9;

S9: compare if time to send data to cloud, (Yes) go S10, otherwise go S2;

S10: send (selected/detected) data to cloud by via NODE-RED IoT block, go S2; Attention: NODE-RED IoT block/(node) used in step S10 is IBM™ Bluemix cloud, other clouds such as Amazon™, MQTT also can be used. The IoT block (node) needs being configured before using, such as IP, data type.

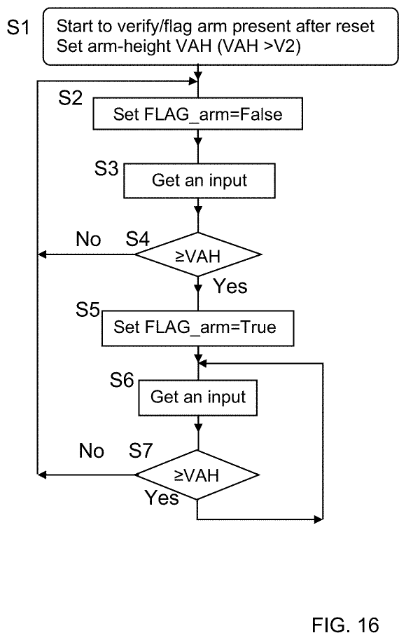

FIG. 16 illustrates a flowchart/algorithm for determining/flagging arm passing

S1: after power-up start to clear all counters/variables (flags), set VAH, go S2;

S2: set arm passing Flag=False, go S3

S3: get an input data from an arm-sensor, go S4;

S4: compare if the input data is valid arm data, (Yes) go S5, otherwise go S2;

S5: Set arm passing Flag=True, go S6;

S6: get an input data from the arm-sensor, go S7

S7: compare if the input data is valid arm data, (Yes) go S6, otherwise arm passed and go S2;

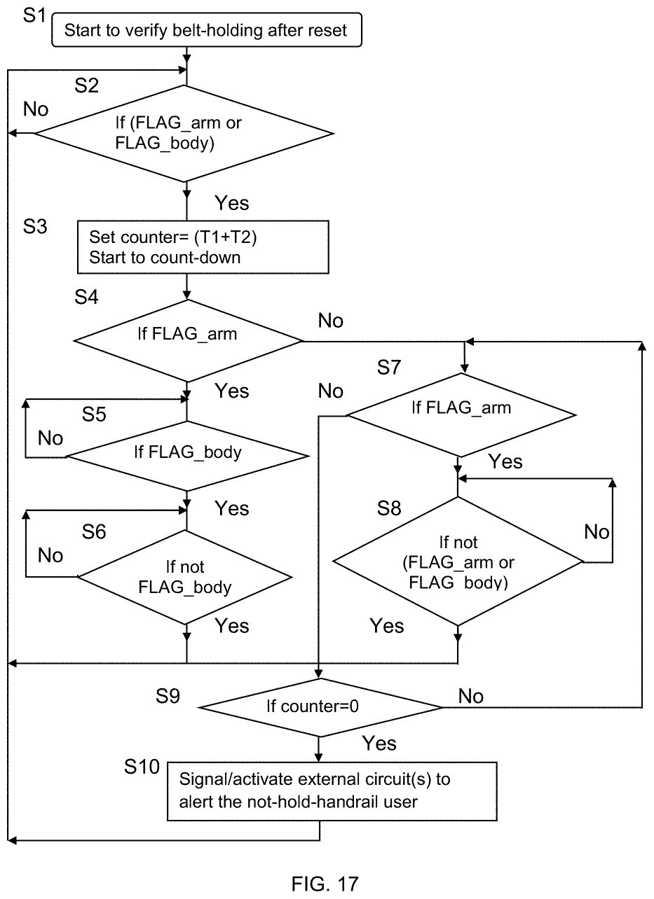

FIG. 17 illustrates a flowchart/algorithm for determining/signaling a not-hold-handrail user.

S1: after power-up start to clear all counters/variables (flags), go S2;

S2: check if body or arm passing, (Yes) go S3, otherwise in S2;

S3: set counter=equivalent count of one cycle (one step passing) time (T1+T2) and start counting down, go S4;

The counter is used for timer purpose and covers the scenarios of a user standing on one and 2 steps.

S4: check if arm passing, (Yes) body data, go S5, otherwise body passing go S7;

S5: check if body passing starts, (Yes) go S6, otherwise in S5;

S6: check if body passed; (Yes) go S2, otherwise in S6;

S7: check if arm passing starts, (Yes) go S8, otherwise body passing goes S9;

S8: check both body and arm passed, (Yes) go S2, otherwise in S8;

S9: check if the counter (timer) runs out, (Yes) this is not-hold-handrail user and go S10, otherwise go S7;

S10: output (via NODE-RED GPIO block, or alternatively FPGA/CPLD 10) one or more signals to activate external circuit(s) to alert the not-hold-handrail user then go S2. The external circuits alert/remind, such as voice, visual light-up, holding handrail immediately for its own safety. The external technology is available and adaptable for the invention, but does not belong to the invention.

Following the linked tutorials can help/guarantee to function, since my prototypes function and are available upon request.

### A Second Embodiment of an Escalator-Monitoring/Operable Device and Variations Thereof

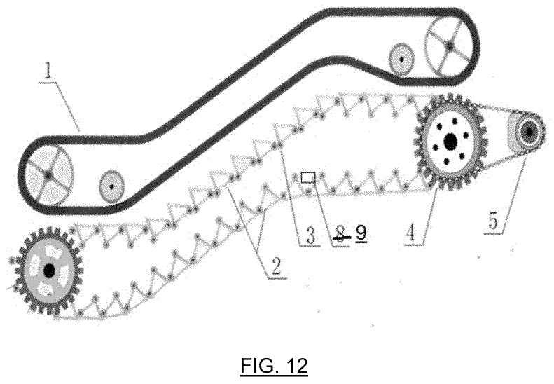

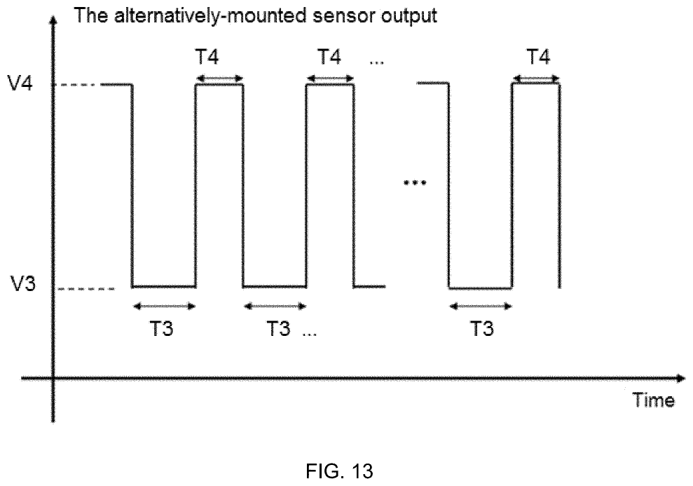

One version of a second embodiment of escalator-monitoring/operable device is best illustrated in FIG. 12 and FIG. 13.

Attention is now directed towards an alternative position to install escalator-sensor 9 is illustrated in FIG. 12.

The escalator-sensor is distance sensor or integrated with distance sensor and installed/mounted to a support surface of a vertical post attached to the ground or a wall bracket and focusing/sensing side of the stair step 2 and a gap between the stair steps. The escalator-sensor, generally, has resolution less than 0.5 meters, frequency response more than 24 Hz and sensing distance more than 0.5 meters. Adjust the position of the sensor if necessary to ensure sensing side of passing step/gap and get waveform similar to that illustrated in FIG. 13. FIG. 13 illustrates waveform of the alternatively mounted escalator-sensor's output, its periodicity cycle times (T3, T4), and variation range (V3, V4) as below:

V3, a constant number, refers to the nearest distance from the escalator-sensor to a passing-by step side in front sensing position illustrated in FIG. 12;

V4, a constant number, refers to the farthest distance from the escalator-sensor to a passing-by step gap in front sensing position illustrated in FIG. 12;

T3, a constant number, refers to the periodic cycle time from V3 to V4 as illustrated in FIG. 13;

T4, a constant number, refers to the periodic cycle time from V4 to V3 as illustrated in FIG. 13;

This embodiment's methods/algorithms/rules are similar but much simpler than those of first embodiment. For example, determine “running”, “stopped” and “Sudden acceleration or deceleration” can be implemented by detecting/comparing the escalator data with the known periodic cycle times and range values (T3, T4, V3, V4) as illustrated in FIG. 13 and Max number of input/count at the sampling rate/clock used over allowed tolerance.

No need to determine escalator vs. body data, since there is no user/body interruption for this configuration as illustrated in FIG. 12.

Directions can be detected by adding another sensor side by side and comparing their phase difference (quadrature) which linked to one of known directions. The detected quadrature phase change mean escalator direction change.

List Analyzing of the (2^{nd}) Embodiment Methods/Algorithms/Rules

| Detection | Category | Rules to detect/determine |
|---|---|---|
| “running” | Normal operation state | If detected consecutive escalator data agree with |
| | | predefined periodic cycle times (T3, T4) and range |
| | | (V3, V4) |
| “Stopped” | Abnormal occurrence | If received data are the same value which is within |
| | | V3 and V4 data and more than Max number of counts/input |
| | | data in one cycle T3 + T4 at sampling rate/clock over |
| | | allowed tolerance |
| “Sudden acceleration | Unsafe/abnormal occurrence | If actual detect number of input data in each cycle |
| or deceleration” | | differs (over or under) predefined number of counts/inputs |
| | | in T3/T4 at sampling rate/clock used over allowed tolerance |

Pros and Cons of this (2^{nd}) Embodiment

Pros:

immune to passenger passing;

ease the sensors' resolution/sensing distance specs, so more suitable ones to use;

more simple method/algorithm of detecting “running”, “stopped”, “Sudden acceleration or deceleration”

Cons:

need accessing to escalator underneath (truss) to install/maintain; need escalator-sensors installed above the escalator to assist for not-hold-handrail detection.

While the alternative embodiment illustrated in FIG. 12 can be used similarly as escalator-monitoring embodiment, such an embodiment and versions thereof are most useful when escalator detection is immune to the users/body passing Further variations and alternative embodiments of the escalator-monitoring/operable device are contemplated as would be apparent to one of skill in the art having the benefit of this disclosure. In sum, embodiments of the escalator-monitoring/operable device can be used therein to create a unique combination to monitor escalator(s).

Exemplary Methods of monitoring one or more escalators New and useful exemplary, including computer-implemented, methods of monitoring one or more escalators is disclosed herein. It is to be understood that the first and second embodiment escalator-monitoring/operable devices can be used in conjunction with the exemplary methods.

The exemplary method of monitoring one or more escalators using at least one escalator-monitoring/operable device and/or one or more non-transitory computer readable storage mediums storing program(s) being executed by the device(s) to perform, typically comprises:

acquiring data from the distance device(s)/sensor(s);

analyzing the data, including: classifying/flagging/storing/separating the data into escalator or user data, calculating/storing the escalator data's cycle range/times, sums of absolute delta consecutive escalator step heights ΣΔL, groups of consecutive user data;

identifying state/events, usage, users' heights, based on the analyzing; and alerting, notifying, receiving/replying, uploading, based on the identifying.

The identifying of the methods/algorithms/rules, including:

| Detection | Category | Rules to detect/determine |
|---|---|---|
| “running” | Normal operation state | If detected consecutive escalator data agree with preset |
| | | periodic cycle times (T1, T2) and range (V1, V2) |
| “Stopped” | Abnormal occurrence | If received are the same value of escalator data |
| | | and more than Max number over allowed tolerance |
| “Jerky movements” | Unsafe/abnormal occurrence | If either detected ΣΔL in T1/T2 differs vertical |
| | | range difference (V2 − V1) over allowed tolerance |
| “Missing stair step” | Unsafe/abnormal occurrence | If escalator data less than Minimum threshold V1 |
| “Sudden acceleration | Unsafe/abnormal occurrence | If number of counts/inputs differs (over or under) |
| or deceleration” | | number of counts/inputs in T1/T2 at sampling |
| | | rate/clock used over allowed tolerance |
| Running direction | Operation state | Defining/link one of known directions to ratio |
| | | and/or logic relationship of T1, T2 detected |
| “Reversing direction” | Unsafe/abnormal occurrence | If ratio and/or logic relationship of T1, T2 changed |
| | | from previously detected/known |
| Not-hold-handrail users | Unsafe usage | If no arm passing, one cycle time (T1 + T2) |
| | | before/after and during a body passing, i.e. no |
| | | arm passing from one cycle time before to/until |
| | | one cycle time after a body passing. |

List of in-response-to operations of the methods, based on the identifying, including:

| In-response-to | Action |
|---|---|
| Abnormal occurrence | Send notifying email(s), such as “Stopped” |
| Not-hold-handrail | Output one or more signal(s) to activate external |
| | circuit(s) to alert/remind |
| Receiving/Replying | Receiving/Replying by sending the latest operation |
| Requests for the state | state to requests for the state via internet/intranet, |
| | alternatively sending the state to MQTT publisher(s) |
| | and letting the publisher(s) to reply requests from |
| | MQTT subscribers |
| Time to send data to cloud | Uploading by sending the detected data to computing/IoT |
| | cloud(s) when a time tick of a system preset interval is due |

The analyzing of the methods, including:

| Detection | Rules to detect/determine |
|---|---|
| generic | Comparing to their preset thresholds or stored values |
| body data | if equal or greater than preset Minimum body height VPH |
| escalator data | if equal or less than the Maximum step height V2 |
| arm-data | if equal or greater than preset Minimum arm height VAH |
| body passing | if all the consecutive input data are body data |
| arm passing | if all the consecutive input data are arm data |
| sum of absolute delta | accumulating of absolute difference of each 2-consecutive |
| consecutive escalator | escalator data received during cycle intervals: |
| step heights ΣΔL | T1(from Minimum to Maximum) and T2(from Maximum to Minimum) |
| periodicity | If all consecutively received data are escalator data and vary |
| | within fixed/same value ranges and at fixed/same time cycles; |
| | the expected value ranges are Minimum step height V1 and |
| | Maximum step height V2; and the expected of cycle times are |
| | T1 and T2 and/or equivalent number of input/count in T1 and T2 |

An Exemplary Method of making escalator-monitoring/operable Devices A new and useful exemplary method of making embodiments of the escalator-monitoring/operable device is additionally disclosed herein. It is to be understood that the first and second embodiment of escalator-monitoring/operable device can be made with this exemplary method of making escalator-monitoring/operable devices.

The exemplary method of making an escalator-monitoring/operable device typically comprises:

Installing the escalator-sensor at the optimal locations decided by 3-dimension disclosed and the arm-sensor at locations decided by 3-dimension specified by an individual or an entity;

Next, when making an escalator-monitoring/operable device, better using threshold ranges/hysteresis with leeway/tolerance instead of absolute values, such as V1, V2, V3, V4, T1, T2, T3, T4, to implement the invention's detecting/comparing. This copes data fluctuations better. For example, comparing if equal to V2 (if =V2),

use if [>(V2−ΔV2_Min) and <(V2+ΔV2_Max)] instead if =V2,

ΔV2_Min refer to V2 unbalanced hysteresis's Minimum leeway/tolerance offset;

ΔV2_Max refer to V2 unbalanced hysteresis's Maximum leeway/tolerance offset;

Alternatively use ΔV2 to replace ΔV2_Min and ΔV2_Max for balanced hysteresis leeway/tolerance;

Further, validating or fine-tuning the optimal locations' periodic cycle times (T1, T2), cycle variation range (V1, V2) and their (allowable) tolerances on an installed final-use device, then to set/calibrate them in one or more programs if necessary.

It is to be appreciated that the method of making escalator-monitoring/operable devices is merely exemplary. Variations of this method can be used to make different embodiments of the escalator-monitoring device as would be apparent to one of ordinary skill given the benefit of this disclosure.

### Alternative Embodiments and Variations

The various embodiments and variations thereof, illustrated in the accompanying figures and/or described above, are merely exemplary and are not meant to limit the scope of the invention. It is to be appreciated that numerous other variations of the invention have been contemplated, as would be obvious to one of ordinary skill in the art, given the benefit of this disclosure.

For example, in embodiments of distance sensors are used for an escalator-monitoring/operable device. Other type sensors, such as some of speed/velocity sensors, they actually integrate/incorporate one or more distance sensors to measure distance and derive speed/velocity. Sensors which integrate distance sensors can alternatively be used for the invention. Since both escalator sensor and arm-sensor can detect stair steps of the escalator, so can their data be used for identifying the escalator's state/event regardless their installation locations. The device/method can reliably identify the users regardless standing, walking on running or stopped escalator. The device/method can use only one sensor (escalator-sensor) when not-hold-handrail detection (arm-sensor) is not needed. It is to be further appreciated that various embodiments of the escalator-monitoring/operable device can comprise non-distance sensors which integrating distance sensors such as, but not limited to, speed/velocity sensors. Moreover, in some variations reduced number of body height groups is preferred to the actual body height.

In yet another alternative embodiment, the escalator-monitoring/operable device can comprise: a FPGA/CPLD and IoT computer.

All variations disclosed in this application are intended and contemplated to be within the spirit and scope of the invention.

The invention claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A computer-implemented method, comprising steps of:
at an escalator-monitoring/operable device;
monitoring/collecting data associated with a stair step and a user of an escalator, including: acquiring the data of the stair step and the user via distance sensing device(s) installed above the escalator;
analyzing the data for escalator data, flags of user data, cycle range, cycle times, cycle times' inequality/ratio, sums of absolute delta consecutive escalator step heights, groups of consecutive user data;
identifying a predetermined state/event and usage of the escalator and the user's height in order to alert/notify/reply/upload, based on the analyzing;
alerting a not-hold-handrail user, based on the identifying, including:
outputting one or more signals to trigger/activate an external device/circuit to alert the not-hold-handrail user;
notifying the event occurrence(s), based on the identifying, including: sending email(s) to notify the escalator's maintenance and/or traffic-control personnel when any event has occurred;
receiving/replying a request for the state, based on the identifying, including:
receiving the request and replying by sending the state to the request via internet/intranet;
and uploading, based on the identifying, including: sending the identified data to one or more computing/IoT cloud(s) via internet/intranet at a system preset interval.

19. The method cited in claim 1, wherein said distance sensing device(s) detect(s) height change in distance between the stair step or the user and the distance sensing device(s) at a time.

20. The method cited in claim 1, wherein said analyzing the data, further comprising steps of:
classifying type of the data, including: classifying/storing/separating the data into escalator data or user data by comparing the data to predefined values of the escalator and the user;
flagging/storing flags of said escalator data and flags of said user data to indicate the type of the data;
processing said escalator data, based on the escalator data and said flags of the escalator data, including:
calculating/storing Min/Max values by comparing the latest escalator data to the stored escalator data, calculating/storing cycle times T1/T2 (or in a number of the data/acquisition) by counting the T1 (from the Min to the Max), the T2 (from the Max to the Min) and determining the T1/T2 inequality/ratio, calculating/storing cycle range by finding Min/Max values during T1 and T2, and calculating/storing sums of absolute delta consecutive escalator step heights ΣΔL during T1 and T2;
processing said user data, based on said user data and said flags of the user data, including:
identifying groups of consecutive user data by detecting validity of said flags of the user data, and identifying numbers of user data of the groups of consecutive user data within predefined thresholds of the escalator, and determining users.

21. The method cited in claim 1, wherein said identifying the predetermined state/event, the usage and the user's height, further comprising steps of:
identifying the cycle range, the cycle times within predefined thresholds of the escalator, and determining state of normal running;
identifying the cycle times, and/or the cycle times' inequality/ratio exceeding predefined thresholds of the escalator, and determining event of “stopped”;
identifying the sums of absolute delta consecutive escalator step heights (ΣΔL) exceeding predefined thresholds of the escalator, and determining event of “Jerky movements”;
identifying the cycle times, and/or the cycle times' inequality/ratio exceeding predefined thresholds of the escalator, and determining event of “Sudden acceleration”;
identifying the cycle times, and/or the cycle times' inequality/ratio exceeding predefined thresholds of the escalator, and determining event of “Sudden deceleration”;
identifying the cycle times, and/or the cycle times' inequality/ratio exceeding predefined thresholds of the escalator, and determining event of “Reversing direction”;
identifying the escalator data exceeding a predefined threshold (V1 in FIG. 4, 5, 6, 7, 8,11) of the escalator, and determining event of “Missing stair step”;
identifying and determining the usage in numbers of the user(s) by counting/adding/storing numbers of the groups of consecutive user data;
identifying and determining the users' heights by finding Maximum values in the groups of consecutive user data and linking/assigning the Maximum values to the users' heights;
identifying that only one of the flags of the user data of the distance sensing devices is valid within twice of the cycle time (2*[T1+T2]), and determining a “not-hold-handrail” user;
and identifying and determining numbers of the not-hold-handrail users by counting/adding/storing the numbers of the not-hold-handrail user(s).

22. The method cited in claim 4, wherein said identifying a predetermined state/event is independent of installation locations of the distance sensing devices 9, 12 in FIG. 3, 9, 10, 12.

23. The method cited in claim 4, wherein said identifying the usage is independent of the users' standing still or moving on the escalator of being running or stopped.

24. An escalator-monitoring/operable device, comprising:
one or more distance sensing device(s) installed above an escalator and configured to detect height change in distance between the escalator's stair step/user and the distance sensing device(s) at a time;
an IoT device configured to transmit data/message via internet/intranet;
an IO device configured to input/output signals for interfacing external device(s)/circuit(s);
a processing device configured to perform a method of analyzing data in order to identify a predetermined state/event, usage of the escalator, the user's height and when needed to notify/alert/reply/upload, by executing program instructions and/or function blocks, comprising steps of:
monitoring/collecting the data associated with the stair step and the user, utilizing the processing device, including: acquiring the data via the distance sensing device(s);
analyzing the data for escalator data, flags of user data, cycle range, cycle times, cycle times' inequality/ratio, sums of absolute delta consecutive escalator step heights, groups of consecutive user data, utilizing the processing device;
identifying a predetermined state/event and usage of the escalator, and the user's height in order to alert/notify/reply/upload, based on the analyzing, utilizing the processing device;
alerting a not-hold-handrail user, based on the identifying, utilizing the processing device and the IO device, including: outputting one or more signals to trigger/activate external device/circuit to alert the not-hold-handrail user;
notifying the event occurrence(s), based on the identifying, utilizing the processing device and the IoT device, including: sending email(s) to notify the escalator's maintenance and/or traffic-control personnel when any abnormal event has occurred;
receiving/replying a request for the state, based on the identifying, utilizing the processing device and the IoT device, including: receiving the request and replying by sending the state to the request via internet/intranet;
and uploading, based on the identifying, utilizing the processing device and the IoT device, including: sending the identified data to one or more computing/IoT cloud(s) via internet/intranet at a system preset interval;
and a communication media configured to connect said distance sensing devices(s), said IoT device, said IO device, said processing device and internet/intranet.

25. The device cited in claim 7, wherein said distance sensing device(s) comprise(s) distance sensor(s).

26. The device cited in claim 7, wherein said IoT device is an independent functional device and/or integrated in said processing device(s).

27. The device cited in claim 7, wherein said IO device is an independent functional device and/or integrated in said processing device(s).

28. The device cited in claim 7, wherein said processing device comprises processor(s).

29. The device cited in claim 7, wherein said communication media is wired and/or wireless.

30. The device cited in claim 7, wherein said analyzing the data, further comprising steps of:
classifying type of the data, including: classifying/storing/separating the data into escalator data or user data by comparing the data to predefined values of the escalator and the user;
flagging/storing flags of said escalator data and flags of said user data to indicate the type of the data;
processing said escalator data, based on the escalator data and said flags of the escalator data, including:
calculating/storing Min/Max values by comparing the latest escalator data to the stored escalator data, calculating/storing cycle times T1/T2 (or in a number of the data/acquisition) by counting the T1 (from the Min to the Max), the T2 (from the Max to the Min) and determining the T1/T2 inequality/ratio, calculating/storing cycle range by finding Min/Max values during T1 and T2, and calculating/storing sums of absolute delta consecutive escalator step heights ΣΔL during T1 and T2;
processing said user data, based on said user data and said flags of the user data, including:
identifying groups of consecutive user data by detecting validity of said flags of the user data, and identifying numbers of user data of the groups of consecutive user data within predefined thresholds of the escalator, and determining users.

31. The device cited in claim 7, wherein said identifying the predetermined state/event, the usage and the user's height, further comprising steps of:
identifying the cycle range, the cycle times within predefined thresholds of the escalator, and determining normal running;
identifying the cycle times, and/or the cycle times' inequality/ratio exceeding predefined thresholds of the escalator, and determining state of “stopped”;
identifying the sums of absolute delta consecutive escalator step heights (ΣΔL) exceeding predefined thresholds of the escalator, and determining event of “Jerky movements”;
identifying the cycle times, and/or the cycle times' inequality/ratio exceeding predefined thresholds of the escalator, and determining event of “Sudden acceleration”;
identifying the cycle times, and/or the cycle times' inequality/ratio exceeding predefined thresholds of the escalator, and determining event of “Sudden deceleration”;
identifying the cycle times, and/or the cycle times' inequality/ratio, exceeding predefined thresholds of the escalator, and determining event of “Reversing direction”;
identifying the escalator data exceeding predefined a threshold (V1 in FIGS. 4, 5, 6, 7, 8, 11) of the escalator, and determining event of “Missing stair step”;
identifying and determining the usage in numbers of the user(s) by counting/adding/storing numbers of the groups of consecutive user data;
identifying and determining the users' heights by finding Maximum values in the groups of consecutive user data and linking/assigning the Maximum values to the users' heights;
identifying that only one of the flags of the user data of the distance sensing devices is valid within twice of the cycle time (2*[T1+T2]), and determining a “not-hold-handrail” user;
and identifying and determining numbers of the not-hold-handrail users by counting/adding/storing the numbers of the not-hold-handrail user(s).

32. The device cited in claim 7, wherein said distance sensing device(s) 9, is/are, alternatively, installed/mounted to a support surface of a vertical post attached to the ground or a wall bracket and focusing/sensing side of lower portion of loop of the stair step 2 and a gap between the stair steps in FIG. 12.

33. A non-transitory computer readable storage medium used for storing one or more programs, the one or more programs comprising instructions and/or functional blocks, which when executed by one or more processor(s) in an escalator-monitoring/operable device, cause the processor(s)/device to perform a method comprising steps of:
monitoring/collecting data associated with a stair step and a user of an escalator, including: acquiring the data of the stair step and the user via distance sensing device(s) installed above the escalator;
analyzing the data for escalator data, flags of user data, cycle range, cycle times, cycle times' inequality/ratio, sums of absolute delta consecutive escalator step heights, groups of consecutive user data;
identifying a predetermined state/event and usage of the escalator and the user's height in order to alert/notify/reply/upload, based on the analyzing;
alerting a not-hold-handrail user, based on the identifying, including:
outputting one or more signals to trigger/activate an external device/circuit to alert the not-hold-handrail user;
notifying the event occurrence(s), based on the identifying, including: sending email(s) to notify the escalator's maintenance and/or traffic-control personnel when any event has occurred;
replying a request for state of the escalator, based on the identifying, including: sending the determined state to the request via internet/intranet;
receiving/replying a request for the state, based on the identifying, including:
receiving the request and replying by sending the state to the request via internet/intranet;
and uploading, based on the identifying, including: sending the identified data to one or more computing/IoT cloud(s) via internet/intranet at a system preset interval.

34. The medium cited in claim 16, wherein said analyzing the data, further comprising steps of:
classifying type of the data, including: classifying/storing/separating the data into escalator data or user data by comparing the data to predefined values of the escalator and the user;
flagging/storing flags of said escalator data and flags of said user data to indicate the type of the data;
processing said escalator data, based on the escalator data and said flags of the escalator data, including:
calculating/storing Min/Max values by comparing the latest escalator data to the stored escalator data, calculating/storing cycle times T1/T2 (or in a number of the data/acquisition) by counting the T1 (from the Min to the Max), the T2 (from the Max to the Min) and determining the T1/T2 inequality/ratio, calculating/storing cycle range by finding Min/Max values during T1 and T2, and calculating/storing sums of absolute delta consecutive escalator step heights ΣΔL during T1 and T2;
processing said user data, based on said user data and said flags of the user data, including:
identifying groups of consecutive user data by detecting validity of said flags of the user data, and identifying numbers of user data of the groups of consecutive user data within predefined thresholds of the escalator, and determining users.

35. The medium cited in claim 16, wherein said identifying the predetermined state/event, the usage, and the user's height, further comprising steps of:
identifying the cycle range, the cycle times within predefined thresholds of the escalator, and determining state of normal running;
identifying the cycle times, and/or the cycle times' inequality/ratio exceeding predefined thresholds of the escalator, and determining event of “stopped”;
identifying the sums of absolute delta consecutive escalator step heights (ΣΔL) exceeding predefined thresholds of the escalator, and determining event of “Jerky movements”;
identifying the cycle times, and/or the cycle times' inequality/ratio exceeding predefined thresholds of the escalator, and determining event of “Sudden acceleration”;
identifying the cycle times, and/or the cycle times' inequality/ratio exceeding predefined thresholds of the escalator, and determining event of “Sudden deceleration”;
identifying the cycle times, and/or the cycle times' inequality/ratio exceeding predefined thresholds of the escalator, and determining event of “Reversing direction”;
identifying the escalator data exceeding a predefined threshold (V1 in FIGS. 4, 5, 6, 7, 8,11) of the escalator, and determining event of “Missing stair step”;
identifying and determining the usage in numbers of the user(s) by counting/adding/storing numbers of the groups of consecutive user data;
identifying and determining the users' heights by finding Maximum values in the groups of consecutive user data and linking/assigning the Maximum values to the users' heights;
identifying that only one of the flags of the user data of the distance sensing devices is valid within twice of the cycle time (2*[T1+T2]), and determining a “not-hold-handrail” user;
and identifying and determining numbers of the not-hold-handrail users by counting/adding/storing the numbers of the not-hold-handrail user(s).
